(19) United States
(12) Patent Application Publication
(10) Pub. No.: US 2012/0319998 A1
(43) Pub. Date: Dec. 20, 2012

(54) REFLECTING SHEET AND OPTICAL TOUCH DEVICE USING THE SAME

(75) Inventors: Hung-Ching Lai, Hsinchu (TW); Cheng-Nan Tsai, Hsinchu (TW)

(73) Assignee: PixArt Imaging Inc., Hsinchu City (TW)

(21) Appl. No.: 13/472,469

(22) Filed: May 15, 2012

(30) Foreign Application Priority Data
Jun. 16, 2011 (TW) 100121109

(51) Int. Cl. G06F 3/042; G02B 27/14

(52) U.S. Cl. 345/175; 359/627

(57) ABSTRACT

A reflecting sheet includes a base, a plurality of protruding structure and a plurality of reflecting micro structures. The base has a first surface. The protruding structures are disposed on the first surface of the base. The reflecting micro structures are disposed on the protruding structures. An optical touch device using the reflecting sheet is also provided. The reflecting sheet can effectively reflect incident light rays with different incident angles. The optical touch device has simple structure and is easily assembled.

### FIELD OF THE INVENTION

The present invention relates to an optical element and a touch device, and more particularly to a reflecting sheet and an optical touch device using the same.

### BACKGROUND OF THE INVENTION

Touch devices are easily operated, so that in recent years the touch devices have been widely used in many electronic products, such as mobile phones, personal digital assistants (PDAs), digital cameras, music players, computers, satellite navigation devices, touch screens and so on. Generally, touch devices includes resistive touch devices, capacitive touch devices and optical touch devices. The optical type touch devices have good durability and low cost, so the optical touch devices are getting more and more attention.

The optical touch devices need to provide light rays to a sensing area, such that a light sensing element can sense the position of touch point. Conventional technology adopts a reflecting sheet or a light guide element to guide light rays emitted by a light emitting element to the sensing area.

FIG. 1 is a schematic, top view of a conventional optical touch device using reflecting sheets. Referring to FIG. 1, a conventional optical touch device 100 has a sensing area 101 and includes light sensing elements 110a, 110b, light sources 120a, 120b and reflecting sheets 130a, 130b, 130c. The light sensing element 110b and light sensing element 110a are disposed beside the sensing area 101 and are respectively located on two ends of a first side 101a of the sensing area 101. The light source 120a is disposed on the light sensing element 110a, and the light source 120b is disposed on the light sensing element 110b. The reflecting sheet 130a is disposed beside a second side 101b of the sensing area 101, the reflecting sheet 130b is disposed beside a third side 101c of the sensing area 101, and the reflecting sheet 130c is disposed beside a fourth side 101d of the sensing area 101. The light sources 120a, 120b provide light rays to the sensing area 101. A field of view of the light sensing element 110a covers the reflecting sheets 130b, 130c, and a field of view of the light sensing element 110b covers the reflecting sheets 130a, 130b.

When the optical touch device 100 works, the reflecting sheets 130a, 130b, 130c reflect the light rays emitted by the light sources 120a, 120b, and the light sensing elements 110a, 110b senses the light rays reflected by the reflecting sheets 130a, 130b, 130c. When a light shading object (such as a finger or a pen) is operated in the sensing area 101, the light shading object can cause the light sensing elements 110a, 110b to detect a dark area, and the position of the light shading object can be calculated according to the position of the dark area detected by the light sensing elements 110a, 110b.

However, in the conventional optical touch device 100, incident angles of light rays provided by the light source 120a in an area R1 near a connecting position between the reflecting sheet 130b and the reflecting sheet 130c are large, so the reflection effect is reduced. Similarly, incident angles of light rays provided by the light source 120b in an area R2 near a connecting position between the reflecting sheet 130a and the reflecting sheet 130b are large, so the reflection effect is reduced. Therefore, brightness of the corners (i.e. the areas R1, R2) of the sensing area 101 is darker, which reduces sensing accuracy of the optical touch device 100.

FIG. 2 is a schematic, top view of another conventional optical touch device using reflecting sheets. Referring to FIG. 2, a conventional optical touch device 100′ is similar to the optical touch device 100, the difference is that, a reflecting sheet 130d′ is connected between a reflecting sheet 130a′ and a reflecting sheet 130b′, and the reflecting sheet 130d′ faces a light source 120b′. Furthermore, a reflecting sheet 130e′ is connected between a reflecting sheet 130b′ and a reflecting sheet 130c′, and the reflecting sheet 130e′ faces a light source 120a′. Since incident angles of light rays striking on the reflecting sheets 130d′, 130e′ are small, the reflecting sheets 130d′, 130e′ can effectively reflect the light rays, so as to prevent sensing accuracy of the optical touch device 100′ from being reduced because of low brightness in the corners of the sensing area 101′. However, the structure of the optical touch device 100′ is too complex and assembly process is also complex, thereby reducing production efficiency.

### SUMMARY OF THE INVENTION

The present invention provides a reflecting sheet which can effectively reflect incident light rays with different angles.

The present invention also provides an optical touch device which has simple structure and is easily assembled.

To achieve at least one of the above-mentioned advantages, the present invention provides a reflecting sheet including a base, a plurality of protruding structures and a plurality of reflecting micro structures. The base has a first surface. The protruding structures are disposed on the first surface of the base. The reflecting micro structures are disposed on the protruding structures.

In one embodiment of the present invention, the reflecting sheet further includes a glue bar, the glue bar is disposed on a second surface of the base, and the second surface is opposite to the first surface.

In one embodiment of the present invention, each of the protruding structures is a prism. The prisms are parallel to each other, and bottom surfaces of the adjacent two prisms connected to the first surface are connected with each other.

In one embodiment of the present invention, each of the protruding structures is a triangular prism.

In one embodiment of the present invention, a vertex angle of each of the protruding structures is ranged from 90 degrees to 120 degrees.

In one embodiment of the present invention, each of the protruding structures is a semi-cylinder. The semi-cylinders are parallel to each other, and bottom surfaces of adjacent two semi-cylinders connected to the first surface are connected with each other.

In one embodiment of the present invention, the reflecting micro structures are pyramids or glass microspheres.

In one embodiment of the present invention, the reflecting sheet further includes a protecting film configured to cover the reflecting micro structures.

In one embodiment of the present invention, the protecting film is a light filtering film.

In one embodiment of the present invention, the base and the protruding structures are integrated into one piece.

In one embodiment of the present invention, material of the base and the protruding structures includes thermoplastic polyurethane (TPU).

The present invention also provides an optical touch device having a sensing area. The optical touch device includes at least one reflecting sheet, at least one light source and at least one light sensing element. The at least one reflecting sheet is disposed beside at least one side of the sensing area. Each reflecting sheet includes a base, a plurality of protruding structures and a plurality of reflecting micro structures. The base has a first surface. The protruding structures are disposed on the first surface of the base. The reflecting micro structures are disposed on the protruding structures. The at least one light source is disposed beside the sensing area and configured to provide light rays to the sensing area. The at least one light sensing element is disposed beside the sensing area, and a field of view of each light sensing element covers the at least one corresponding reflecting sheet.

The reflecting sheet of the present invention has the protruding structures and the reflecting micro structures disposed on the protruding structures. Therefore, the reflecting sheet can effectively reflect light rays with different incident angles. The optical touch device of the present invention can eliminate darkness in the corners of the sensing area because of using the reflecting sheet, so as to promote sensing accuracy of the optical touch device. Moreover, the optical touch device of the present invention has simple structure and is easily assembled.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic, top view of a conventional optical touch device using reflecting sheets.

FIG. 2 is a schematic, top view of another conventional optical touch device using reflecting sheets.

FIG. 3 is a schematic, top view of an optical touch device according to an embodiment of the present invention.

FIG. 4 is a schematic, cross-sectional view of a reflecting sheet of the optical touch device of FIG. 3.

FIG. 5 is a schematic, three-dimensional view of a reflecting micro structure of a reflecting sheet according to another embodiment of the present invention.

FIG. 6 is a schematic, cross-sectional view of a reflecting sheet according to another embodiment of the present invention.

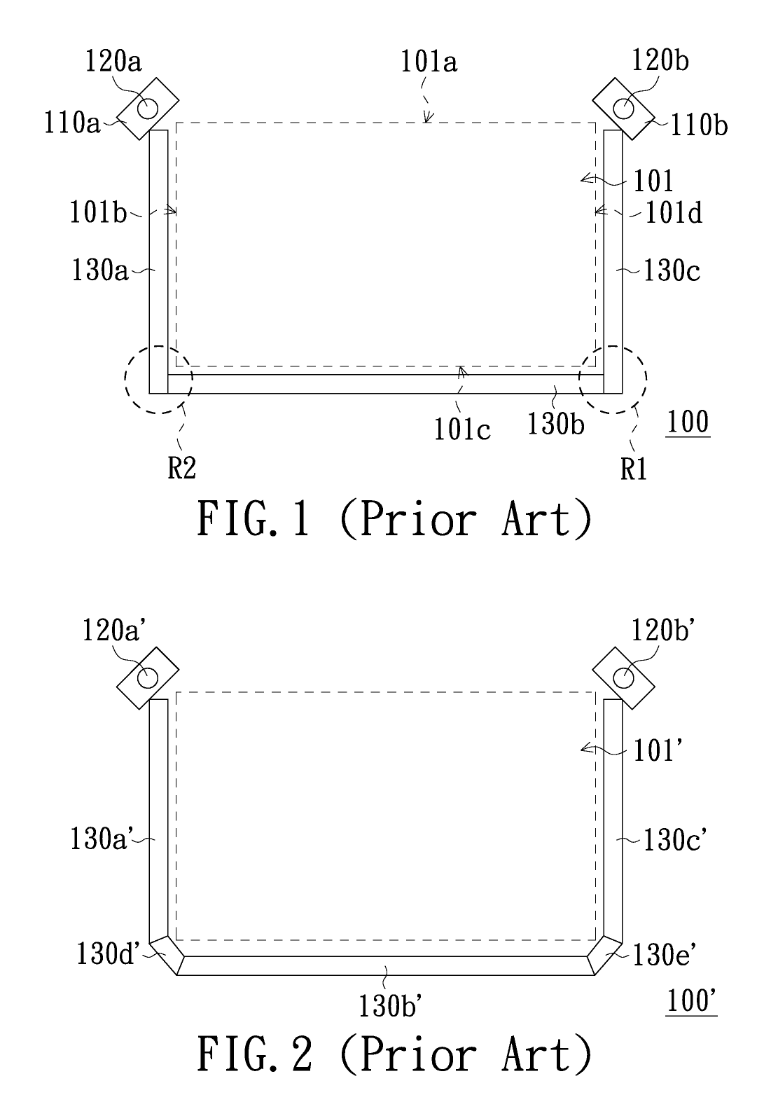

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

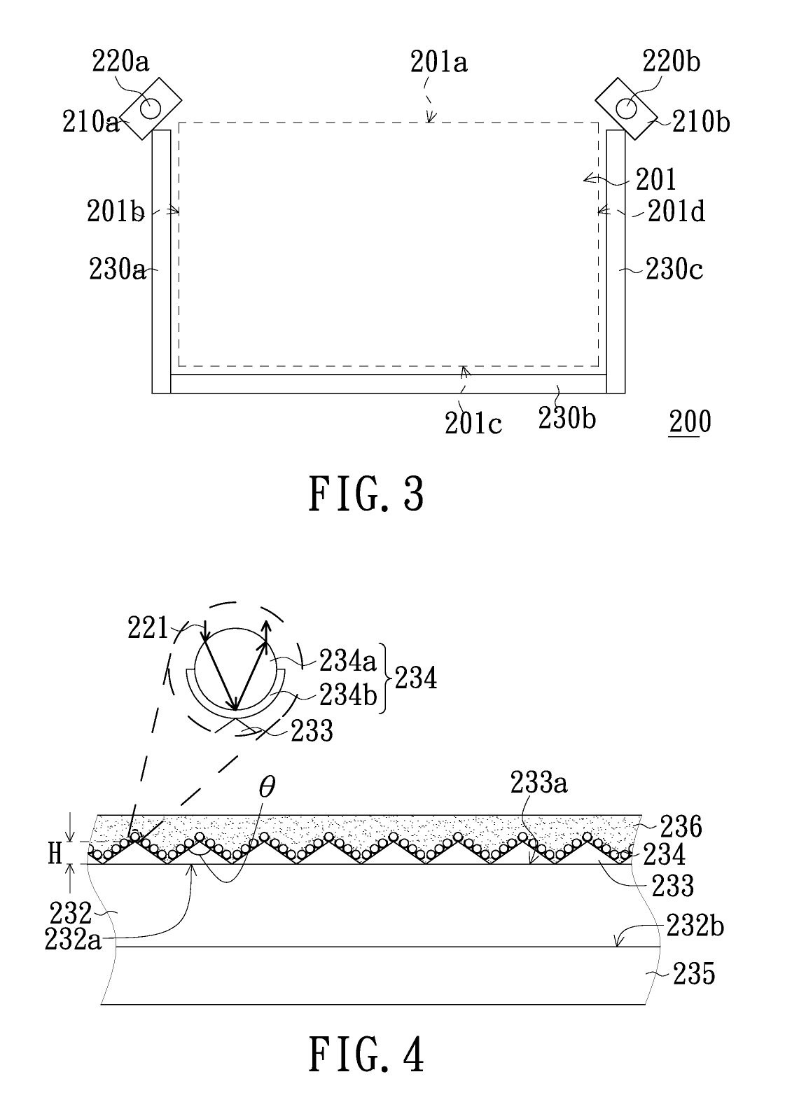

FIG. 3 is a schematic, top view of an optical touch device according to an embodiment of the present invention. Referring to FIG. 3, an optical touch device 200 of the present embodiment has a sensing area 201 and includes at least one reflecting sheet, at least one light source disposed beside the sensing area 201 and at least one light sensing element disposed beside at least one side of the sensing area 201. In the present embodiment, the at least one light sensing element, for example, includes light sensing elements 210a, 210b disposed on two ends of a side 201a of the sensing area 201. The light sensing elements 210a, 210b can be complementary metal oxide semiconductor (CMOS) image sensing elements, charge coupled devices (CCDs) or other suitable light sensing elements. Furthermore, the at least one light source, for example, includes a light source 220a disposed on the light sensing element 210a and a light source 220b disposed on the light sensing element 210b. The light sources 220a, 220b can be light emitting diodes, laser diodes or other suitable light sources. Additionally, the at least one reflecting sheet, for example, includes a reflecting sheet 230a disposed beside a side 201b of the sensing area 201, a reflecting sheet 230b disposed beside a side 201c of the sensing area 201 and a reflecting sheet 230c disposed beside a side 201d of the sensing area 201. It should be noted that, the present invention does not limit a number of the light sensing element, the light source or the reflecting sheet. In other embodiments, the number of the reflecting sheet, the light source or the light sensing element can be adjusted according to actual requirement. In addition, the sensing area 201 can be located on a surface of a substrate, and the substrate can be a supporting plate (such as a glass substrate or other rigid substrate). In another embodiment, the substrate can be a display panel, that is, the optical touch device 200 can be integrated with a touch display device.

FIG. 4 is a schematic, cross-sectional view of a reflecting sheet of the optical touch device of FIG. 3. Referring to FIG. 3 and FIG. 4, each of the reflecting sheets 230a, 230b, 230c includes a base 232, a plurality of protruding structures 233 and a plurality of reflecting micro structures 234. The base 232 has a first surface 232a and a second surface 232b, wherein the second surface 232b is opposite to the first surface 232a, and the first surface 232a faces the sensing area 201. The protruding structures 233 are disposed on the first surface 232a of the base 232, and the reflecting micro structures 234 are disposed on the protruding structures 233. In the present embodiment, the base 232 and the protruding structures 233 are, for example, but not limited to, integrated into one piece. In another embodiment, the base 232 and the protruding structures 233 can be separately formed. Material of the base 232 and the protruding structures 233, for example, includes thermoplastic polyurethane (TPU).

Each of the protruding structures 233 of the present embodiment is, for example, a prism. The prisms are parallel to each other, and bottom surfaces 233a of the adjacent two prisms connected to the first surface 232a are connected with each other, that is, there isn't any gap between the adjacent two protruding structures 233. However, in another embodiment, the bottom surfaces 233a of the adjacent two prisms connected to the first surface 232a do not have to be connected with each other, that is, the adjacent two protruding structures 233 are spaced apart a certain distance. Furthermore, in the present embodiment, each of the protruding structures 233 is, for example, a triangular prism, and a vertex angle θ of each of the protruding structures 233 is, for example, ranged from 90 degrees to 120 degrees. A width of the bottom surface 233a of each protruding structure 233 connected to the first surface 232a is, for example, ranged from 1 millimeter to 2 millimeters. A height H of each of the protruding structures 233 is, for example, about 1 millimeter. The protruding structures 233 can be manufactured by embossed technology, and reflection effect of the reflecting sheets 230a, 230b, 230c can be controlled by adjusting the height H and the vertex angle θ of the protruding structures 233.

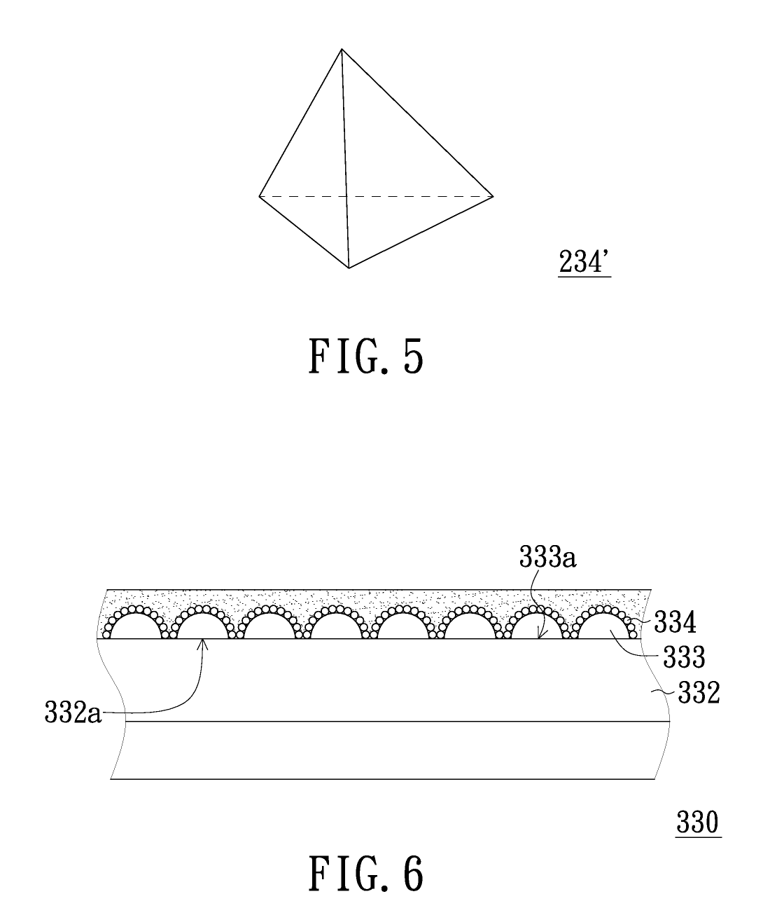

The above-mentioned reflecting micro structures 234 are, for example, glass microspheres. A diameter of each of the glass microspheres is, for example, about 100 micrometers. Each of the glass microspheres, for example, includes a bead portion 234a and a reflecting film 234b disposed between the bead portion 234a and the protruding structure 233. The bead portion 234a is configured to refract light rays 221 provided by the light sources 220a, 220b. The reflecting film 234b is, for example, a metal film (such as an aluminum film), which is configured to reflect the light rays 221. Furthermore, the present invention does not limit the reflecting micro structures to be glass microspheres, for example, as shown in FIG. 5, each reflecting micro structure 234′ can be a pyramid.

In the present embodiment, each of the reflecting sheets 230a, 230b, 230c may further include a glue bar 235. The glue bar 235 is disposed on the second surface 232b of the base 232 and is configured to support the base 232. Furthermore, each of the reflecting sheets 230a, 230b, 230c may further include a protecting film 236 configured to cover the reflecting micro structures 234, so as to protect the reflecting micro structures 234. There may by tiny gaps formed between the protecting film 236 and the reflecting micro structures 234, so that the reflecting micro structures 234 can provide better reflection effect. In another embodiment, the protecting film 236 can be a light filtering film, so as to filter light rays which are not in special wavelength range, and thereby the sensing accuracy of the optical touch device 200 can be promoted. For example, when the light rays 221 provided by the light sources 220a, 220b are infrared light rays, the protecting film 236 can allow the infrared light rays to pass through the protecting film 236 and can block the other light rays which are not the infrared light rays.

When the optical touch device 200 of the present embodiment works, since the protruding structures 233 of the reflecting sheets 230a, 230b, 230c enable the reflecting micro structures 234 to face different directions, the reflecting sheets 230a, 230b, 230c can effectively reflect light rays 221 with different incident angles. Therefore, the reflecting sheets 230a, 230b, 230c can effectively reflect the light rays with large incident angles, so as to prevent the corners of the sensing area 201 from being darker, and thereby the sensing accuracy of the optical touch device 200 can be promoted. Furthermore, compared with the conventional optical touch device 100′, since the additional reflecting sheets disposed in the corners of the sensing area 201 of the optical touch device 200 are not needed, the structure of the optical touch device 200 is simple, thereby promoting assembly efficiency of the optical touch device 200.

FIG. 6 is a schematic, cross-sectional view of a reflecting sheet according to another embodiment of the present invention. Referring to FIG. 6, the structure of a reflecting sheet 330 of the present embodiment is similar to the structure of the reflecting sheets 230a, 230b, 230c, the difference is that, each of protruding structures 333 of the reflecting sheet 330 is a semi-cylinder. The semi-cylinders are parallel to each other, and bottom surfaces 333a of the adjacent two semi-cylinders connected to a first surface 332a of a base 332 are connected with each other. It should be noted that, the present invention does not limit the protruding structures to be prisms or semi-cylinders. In other embodiments, cross-section of the protruding structures can be wave-shaped or circular arcs connected with each other. In the present embodiment, the reflecting micro structures 334 are, for example, glass microspheres. In another embodiment, the reflecting micro structures can be pyramids. Furthermore, the reflecting sheet 330 of the present embodiment can replace the above-mentioned reflecting sheets 230a, 230b, 230c, so as to provide the function similar to that of the reflecting sheets 230a, 230b, 230c.

In summary, the reflecting sheet of the present invention has the protruding structures, which make the reflecting micro structures disposed on the protruding structures face different directions. Therefore, the reflecting sheet of the present invention can effectively reflect light rays with different incident angles. The optical touch device of the present invention can eliminate darkness in the corners of the sensing area because of using the reflecting sheet, so as to promote the sensing accuracy of the optical touch device. Moreover, the structure of the optical touch device of the present invention is simple, so that the assembly efficiency can be promoted.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A reflecting sheet comprising:
a base having a first surface;
a plurality of protruding structures disposed on the first surface of the base; and
a plurality of reflecting micro structures disposed on the protruding structures.

2. The reflecting sheet according to claim 1, further comprising a glue bar, wherein the glue bar is disposed on a second surface of the base, and the second surface is opposite to the first surface.

3. The reflecting sheet according to claim 1, wherein each of the protruding structures is a prism, the prisms are parallel to each other, and bottom surfaces of the adjacent two prisms connected to the first surface are connected with each other.

4. The reflecting sheet according to claim 3, wherein each of the protruding structures is a triangular prism.

5. The reflecting sheet according to claim 4, wherein a vertex angle of each of the protruding structures is ranged from 90 degrees to 120 degrees.

6. The reflecting sheet according to claim 1, wherein each of the protruding structures is a semi-cylinder, the semi-cylinders are parallel to each other, and bottom surfaces of the adjacent two semi-cylinders connected to the first surface are connected with each other.

7. The reflecting sheet according to claim 1, wherein the reflecting micro structures are pyramids or glass microspheres.

8. The reflecting sheet according to claim 1, further comprising a protecting film configured to cover the reflecting micro structures.

9. The reflecting sheet according to claim 8, wherein the protecting film is a light filtering film.

10. The reflecting sheet according to claim 1, wherein the base and the protruding structures are integrated into one piece.

11. The reflecting sheet according to claim 10, wherein material of the base and the protruding structures comprises thermoplastic polyurethane.

12. An optical touch device having a sensing area, the optical touch device comprising:
at least one reflecting sheet disposed beside at least one side of the sensing area, each reflecting sheet comprising:
a base having a first surface facing the sensing area;
a plurality of protruding structures disposed on the first surface of the base;
a plurality of reflecting micro structures disposed on the protruding structures;
at least one light source disposed beside the sensing area and configured to provide light rays to the sensing area; and
at least one light sensing element disposed beside the sensing area, and a field of view of each light sensing element covering the at least one corresponding reflecting sheet.

13. The optical touch device according to claim 12, wherein each reflecting sheet further comprises a glue bar, the glue bar is disposed on a second surface of the base, and the second surface is opposite to the first surface.

14. The optical touch device according to claim 12, wherein each of the protruding structures is a prism, the prisms are parallel to each other, and bottom surfaces of the adjacent two prisms connected to the first surface are connected with each other.

15. The optical touch device according to claim 14, wherein each of the protruding structures is a triangular prism.

16. The optical touch device according to claim 15, wherein a vertex angle of each of the protruding structures is ranged from 90 degrees to 120 degrees.

17. The optical touch device according to claim 12, wherein each of the protruding structures is a semi-cylinder, the semi-cylinders are parallel to each other, and bottom surfaces of the adjacent two semi-cylinders connected to the first surface are connected with each other.

18. The optical touch device according to claim 12, wherein the reflecting micro structures are pyramids or glass microspheres.

19. The optical touch device according to claim 12, wherein each reflecting sheet further comprises a protecting film configured to cover the reflecting micro structures.

20. The optical touch device according to claim 19, wherein the protecting film is a light filtering film.

21. The optical touch device according to claim 12, wherein the base and the protruding structures of each reflecting sheet are integrated into one piece.

22. The optical touch device according to claim 21, wherein material of the base and the protruding structures of each reflecting sheet comprises thermoplastic polyurethane.
